(19) United States
(12) Patent Application Publication
(10) Pub. No.: US 2026/0030589 A1
(43) Pub. Date: Jan. 29, 2026

(54) DYNAMIC PLANOGRAM

(71) Applicant: DoorDash, Inc., San Francisco, CA (US)

(72) Inventors: Weiyu Zhou, Bellevue, WA (US); Sarah Olsen, Brooklyn, NY (US); Larry Waldman, San Francisco, CA (US); Chuqi Wang, Sunnyvale, CA (US)

(73) Assignee: DoorDash, Inc., San Francisco, CA (US)

(21) Appl. No.: 19/279,725

(22) Filed: Jul. 24, 2025

Related U.S. Application Data
(60) Provisional application No. 63/675,646, filed on Jul. 25, 2024.

(51) Int. Cl. G06Q 10/087; G06T 3/4038

(52) U.S. Cl. CPC G06Q 10/08724; G06T 3/4038

(57) ABSTRACT

A method includes receiving, by a computer, a plurality of images of portions of a shelf unit from one or more user devices. Each image captures a different portion of the shelf unit. The method also includes creating, by the computer, a planogram of items on the shelf unit using image data from the plurality of images of the portions. The method also includes additional processing using the planogram.

### CROSS-REFERENCES TO RELATED APPLICATIONS

This application claims the benefit of U.S. Provisional Application No. 63/675,646, filed Jul. 25, 2024, which is herein incorporated by reference in its entirety for all purposes.

### SUMMARY

One embodiment is related to a method comprising: receiving, by a computer, a plurality of images of portions of a shelf unit from one or more user devices, each image capturing a different portion of the shelf unit; and creating, by the computer, a planogram of items on the shelf unit using image data from the plurality of images of the portions.

Another embodiment is related to a computer comprising: a processor; and a non-transitory computer readable medium comprising code, executable by the processor for performing operations comprising: receiving a plurality of images of portions of a shelf unit from one or more user devices, each image capturing a different portion of the shelf unit, creating a planogram of items on the shelf unit using image data from the plurality of images of the portions, and performing additional processing using the planogram.

Another embodiment is related to a system comprising: one or more user devices; and a computer comprising: a processor; and a non-transitory computer readable medium comprising code, executable by the processor for performing operations comprising: receiving a plurality of images of portions of a shelf unit from the one or more user devices, each image capturing a different portion of the shelf unit; creating a planogram of items on the shelf unit using image data from the plurality of images of the portions; and performing additional processing using the planogram.

Further details regarding embodiments of the disclosure can be found in the Detailed Description and the Figures.

### BRIEF DESCRIPTION OF THE DRAWINGS

FIG. 1 shows a block diagram of an image processing system according to embodiments.

FIG. 2 shows a block diagram of components of a computer according to embodiments.

FIG. 3 shows a flowchart illustrating an image processing method according to embodiments.

FIG. 4 shows a raw images of shelf portions and bounding boxes according to embodiments.

FIG. 5A shows a diagram that illustrates a planogram that shows stitched images according to embodiments.

FIG. 5B shows a planogram showing position normalization according to embodiments.

FIG. 5C shows a sectioned planogram according to embodiments.

FIG. 6 shows a diagram illustrating two overlapping planograms according to embodiments.

FIG. 7A shows a diagram illustrating disjoint subgraphs in an aisle planogram according to embodiments.

FIG. 7B shows a diagram showing a plurality of edges between two nodes according to embodiments.

FIG. 8 shows a diagram illustrating an overdetermined graph and a least square fit according to embodiments.

FIG. 9 shows a diagram showing a user interface of progress of a user taking pictures of a shelf unit according to embodiments.

FIG. 10 shows a block diagram of a fulfillment processing system according to embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

“Image data” can include information related to a visible impression obtained by a camera, telescope, microscope, or other device, or displayed on a computer or video screen. Image data can include a plurality of pixels, where each pixel can include data that indicates how that pixel is displayed (e.g., a color value, etc.).

A “shelf unit” can include a surfaces upon which items can be displayed. A shelf unit can include horizontal shelves, gondola shelfs, wire rack shelfs, etc. A shelf unit can display a plurality of items and item tags that relate to the items.

An “item tag” can include a label that includes information about an item. An item tag can include a machine readable code (e.g., a barcode, a QR code, etc.), a price, SKU codes, and/or other information that describes the related item. An item tag can be a shelf tag when it is on a shelf and is used to identify an item on the shelf.

A “barcode” can include a machine-readable code that includes a plurality of bars. A barcode can be in the form of numbers and a pattern of parallel lines of varying widths (e.g., bars). A barcode can correspond to and identify a specific item.

A “map” can include data that has a corresponding relationship to other data. A map can include data related to items and how the items relate to one another on a shelf unit. A map can be a topological graph. In some embodiments, a map can be a planogram.

A “planogram” can include diagram that shows how and where specific items can and/or should be placed on shelves. A planogram can indicate items and item locations on a shelf. In some cases, a planogram can indicate a size of an item on a shelf.

A “topological graph” can include a representation of a graph in a plane of distinct vertices connected by edges. The distinct vertices in a topological graph may be referred to as “nodes.” Each node may represent specific information for an event or may represent specific information for a profile of an entity or object. The nodes may be related to one another by a set of edges, E. An “edge” can include an unordered pair composed of two nodes as a subset of the graph G=(V, E), where is G is a graph comprising a set V of vertices (nodes) connected by a set of edges E. For example, a topological graph may represent a transaction network in which a node representing a transaction may be connected by edges to one or more nodes that are related to the transaction, such as nodes representing information of a device, a user, a transaction type, etc. An edge may be associated with a numerical value, referred to as a “weight”, that may be assigned to the pairwise connection between the two nodes. The edge weight may be identified as a strength of connectivity between two nodes and/or may be related to a cost or distance, as it often represents a quantity that is required to move from one node to the next.

The term “node” can include a discrete data point representing specified information. Nodes may be connected to one another in a topological graph by edges, which may be assigned a value known as an edge weight in order to describe the connection strength between the two nodes. For example, a first node may be a data point representing a first item on a shelf unit, and the first node may be connected in a graph to a second node representing a second item on a shelf unit. The connection strength may be defined by an edge weight corresponding to how quickly and easily information may be transmitted between the two nodes. An edge weight may also be used to express a cost or a distance required to move from one node to the next. For example, a first node may be a data point representing a first position of a first item, and the first node may be connected in a graph to a second node for a second position of a second item. The edge weight may be the distance between the first position and the second position.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Managing inventory is a time-consuming and challenging process for service providers. Most service providers (e.g., retail merchants such as grocery stores) are only able to infrequently count their inventory, such as between once per week and once per month. The difficulties compound when a service provider shares information (e.g., through advertising) regarding what items are actually available at the service provider's location.

Currently, employees of resource providers can use handheld barcode scanners to scan individual item tags on shelves to first identify the items on shelves. The resource providers can place the handheld barcode scanner close (e.g., a few inches) to the item tag to scan the single item tag. Scanning the item tag can allow the handheld barcode scanner to identify the one item associated with the one scanned item tag. The scanning process can be slow since employees need to individually scan many item tags in a store. Further, the process is error prone as it can be difficult to remember which item tags have been scanned and which have not been scanned. Scanning can be slow since employees need to scan the items in a whole store one by one.

With this in mind, it can take a long time for a service provider to update their inventory system to accurately identify the items on the shelves at the service provider. It can also take a long time to determine whether or not the items associated with shelf tags are present and in what quantity the items are present on the shelves. Subsequent information updates about the availability of items at a service provider to external parties such as delivery organizations would also be delayed.

In embodiments of the invention, computer vision techniques can be used to scan the items on the shelves. An image detection model can be usually trained on a golden dataset (e.g., a single, authoritative source of data) to identify the SKUs (stock keeping units) from store shelf images. Previous computer vision approaches can have low accuracy.

Further, in previous methods, individual images were considered when identifying items in an image. However, tracking an item in an image over time across images is difficult. Further, it is difficult to account for the relative positioning of items in images.

Embodiments of the disclosure address these problem and other problems individually and collectively.

Embodiments provide for systems and methods of generating, maintaining, and processing planograms. A planogram can include a diagram or model that indicates the placement of items (e.g., products) on shelves (e.g., shelf units). While resource providers can use drawn and/or manually created planograms to map the placement of products on shelves, other entities do not have direct access to this data. There is a need to allow users to create such planograms quickly.

Embodiments of the invention can construct the planograms using images of portions of shelves taken using user devices, such as mobile phones. The images can be adjusted and stitched together to form a combined image. Embodiments can use various computer vision techniques to extract product information on the shelf units using the images (e.g., photos). In some embodiments, using the images, a computer can create local graphs to determine the relative positions of the items in the frame. Also, the computer can stitch those local graphs to a form a larger connected graph of an entire shelf, and can stitch the images of the shelf portions to obtain a larger shelf image. The larger connected graph can be a planogram that comprises a plurality of nodes and a plurality of edges.

The planogram can be formed from stitched images of a shelf. The stitched images can create a full view of the shelf (e.g., a shelf view). The shelf view can be geometric preserving, meaning relative positions and distances between the positions are preserved corresponding to the physical shelf.

For a user (e.g., a transporter, a consumer, an employee, etc.), the planogram can aid in indoor navigation. For example, the planogram can help a user identify that a first item is in a particular section of a particular aisle on a particular shelf next to a second item and a third item at the resource provider location.

Each item in a planogram, which are represented by nodes, can be annotated with data such as availability, category code, catalog image, date updated, size, color, and/or any other data that represents the item or the process of capturing the image of the item.

As an example, a computer, such as an image analysis computer, can receive a plurality of images of portions of a shelf unit from one or more user devices. Each image can capture a different portion of the shelf unit. After receiving the plurality of images, the computer can create a planogram of items on the shelf unit using image data from the plurality of images of the portions. The computer can create the planogram as described in further detail herein. The computer can also perform additional processing using the planogram.

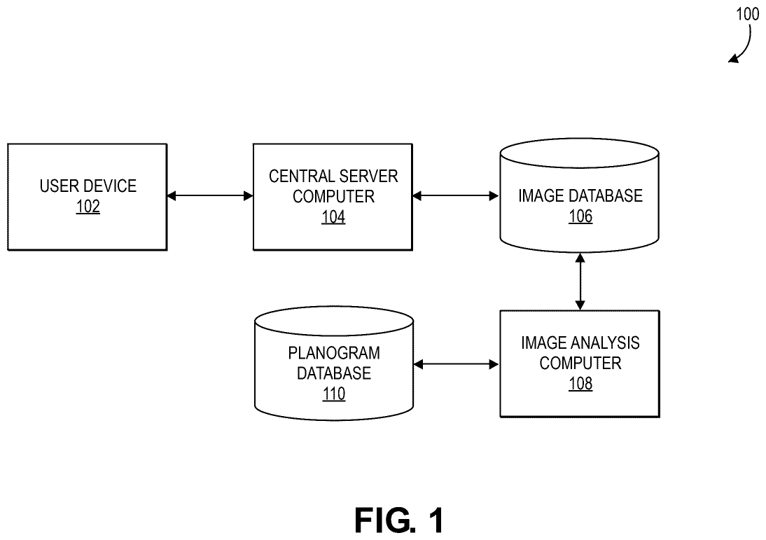

FIG. 1 shows a system 100 according to embodiments of the disclosure. The system 100 comprises a user device 102, a central server computer 104, an image database 106, an image analysis computer 108, and a planogram database 110. The user device 102 can be in operative communication with the central server computer 104, which can be in operative communication with the image database 106. The image database 106 can be in operative communication with the image analysis computer 108. The image analysis computer 108 can be in operative communication with the planogram database 110.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between devices in the system 100 illustrated in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can include an end user device operated by an end user, such as a smartphone, a tablet, a smart wearable device, etc. The user device 102 can include a camera that can capture image data of an image. The user device 102 can provide image data for one or more images to the central server computer 104.

For example, the user device 102 can capture image data of an image of a shelf unit with specific items and item tags comprising machine readable codes adjacent to the specific items. The user device 102 can provide the image data to the central server computer 104. In some embodiments, the user device 102 can capture a plurality of image data and can provide the plurality of image data to the central server computer 104.

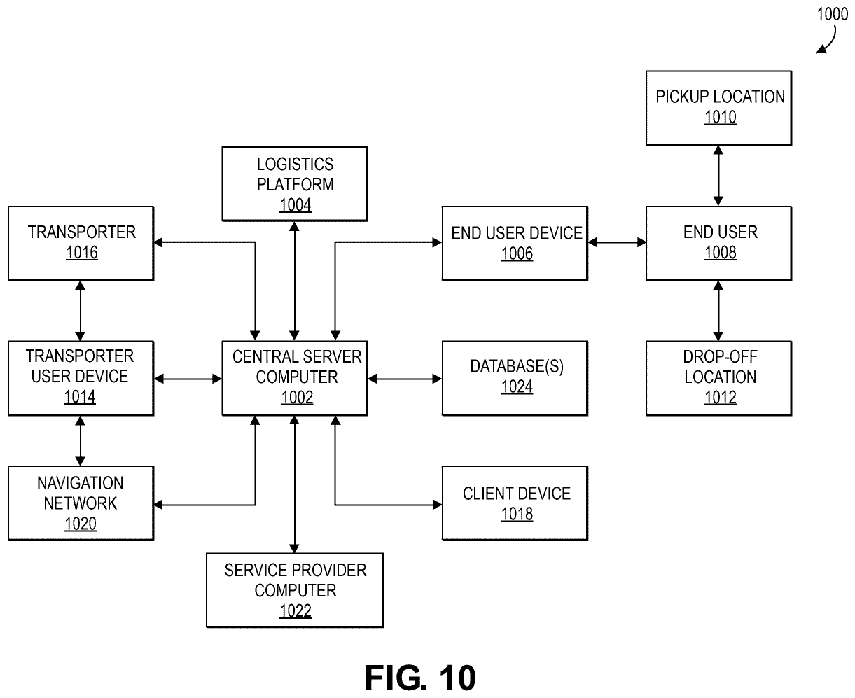

The central server computer 104 can include a server computer that can communicate with a plurality of user devices to obtain image data. The central server computer 104 can be a central server computer 1002 such as the one illustrated in FIG. 10. For example, the central server computer 104 can aid in processing fulfillment requests to provide resources from resource providers to end users via transporters. The central server computer 104 can store received image data into the image database 106.

The image database 106 can store image data. The image database 106 can store image data in association with resource provider identifiers, user device identifiers, shelf unit identifiers, or any other identifiers that can link the image data to devices involved in the capturing of the image data, to the location of the image data, and/or to information related to the contents of the image data. For example, the image database 106 can store information that relates the image data other data. For example, the image database 106 can store the image data in association with a service provider location, a service provider identifier, a service provider location identifier, an aisle number, user device orientation data, image metadata, and/or other data.

The image database 106 can include any suitable database. The database may be a conventional, fault tolerant, relational, scalable, secure database such as those commercially available from Oracle™ or Sybase™. The image database 106 can store image data.

The image analysis computer 108 can be a laptop computer, a desktop computer, a server computer, etc. The image analysis computer 108 can be configured to process image data. The image analysis computer 108 can obtain image data from the image database 106. The image analysis computer 108 can analyze the image data.

The image analysis computer 108 can identify item tags in the image data, modify the item tags in the image data, identify machine readable codes (e.g., barcodes, QR codes, etc.) in the item tags, modify the machine readable codes, and output modified machine readable codes, as described in further detail herein.

The image analysis computer 108 can receive a plurality of images of portions of a shelf unit. Each image can capture a different portion of the shelf unit. The image analysis computer 108 can create a planogram of items on the shelf unit using image data from the plurality of images of the portions. The image analysis computer 108 can then perform additional processing using the planogram.

The planogram database 110 can store planograms. The planogram database 110 can store planograms and data related thereto in association with resource provider identifiers, user device identifiers, shelf unit identifiers, or any other identifiers that can link the planograms to devices involved in the capturing of the image data, to the location of the image data, and/or to information related to the contents of the image data that is related to the planograms. For example, the planogram database 110 can store the planograms in association with a service provider location, a service provider identifier, a service provider location identifier, an aisle number, user device orientation data, image metadata, and/or other data.

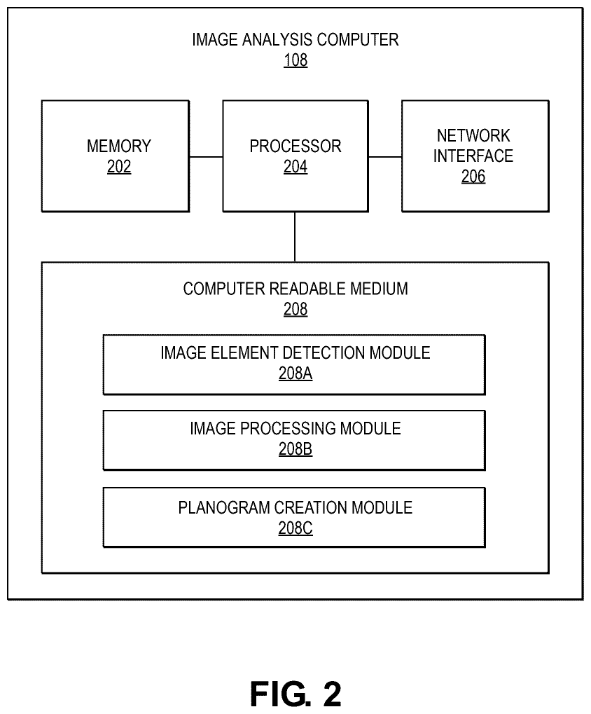

FIG. 2 shows a block diagram of a image analysis computer 108 according to embodiments. The exemplary image analysis computer 108 may comprise a processor 204. The processor 204 may be coupled to a memory 202, a network interface 206, and a computer readable medium 208. The computer readable medium 208 can comprise a plurality of modules including an image element detection module 208A, an image processing module 208B, and a planogram creation module 208C.

The memory 202 can be used to store data and code. For example, the memory 202 can store image data, machine readable code data, item data, planogram data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for receiving a plurality of images of portions of a shelf unit from one or more user devices, each image capturing a different portion of the shelf unit; creating a planogram of items on the shelf unit using image data from the plurality of images of the portions; and performing additional processing using the planogram. In some embodiments, the planogram comprises nodes and edges, the nodes corresponding to item tags associated with items on the shelf unit and the edges correspond to vectors between adjacent item tags. In some embodiments, creating the planogram comprises identifying items corresponding to the item tags and labeling the nodes with names of the identified items. The computer readable medium 208 may comprise code, executable by the processor 204, for identifying the items comprises identifying the items using one or more of: identifying the item using a machine readable code on an item tag corresponding to the item; identifying the item using text on the item tag corresponding to the item; identifying the item using product text on the item; identifying the item using computer vision; and identifying the item using historical data associated with a location of the item on the shelf unit.

The image element detection module 208A may comprise code or software, executable by the processor 204, for identifying image elements in image data. The image element detection module 208A, in conjunction with the processor 204, can identify image elements, such as item tags, machine readable codes, text, items, etc.

The image element detection module 208A, in conjunction with the processor 204, can identify image elements in image data using a machine learning model. The image element detection module 208A, in conjunction with the processor 204, can train, maintain, and utilize a computer vision (CV) machine learning model to identify item tags and/or machine readable codes in image data of shelf units. The image element detection module 208A, in conjunction with the processor 204, can utilize a first computer vision machine learning model to identify item tags in the image data and can utilize a second computer vision machine learning model to identify machine readable codes in item tags. In some embodiments, the first computer vision machine learning model can be the same as the second computer vision machine learning model.

The computer vision machine learning model can be designed to evaluate visual data based on features and contextual information identified during training of the computer vision machine learning model. This training can allow the computer vision machine learning model to interpret images as well as video (e.g., which can be a sequence of images) and apply those interpretations to predictive or decision making tasks.

The computer vision machine learning model can be a convolutional neural network. Convolutional neural networks can be neural networks with a multi-layered architecture that are used to gradually reduce data and calculations to the most relevant set. This most relevant set is then compared against known data (e.g., such as a label) to identify or classify the data input.

When an image is processed by the computer vision machine learning model, each base color used in the image (e.g., red, green, and blue) can represented as a matrix of values. These values are evaluated and condensed into tensors (e.g., a 3 dimensional grid of values in the case of color images), which can be collections of stacks of feature maps tied to a section of the image. These tensors can be created by passing the image through a series of convolutional layers and pooling layers, which are used to extract the most relevant data from an image segment and condense it into a smaller, representative matrix. This process can be repeated numerous times, which can depend on the number of convolutional layers in the architecture. The final features extracted by the convolutional process are sent to a fully connected layer, which can generate predictions.

Computer vision techniques can utilize two different types of object detection: two-step object detection and one-step object detection.

For two-step object detection, the first step can utilize a region proposal network (RPN), which can provide a number of candidate regions that may contain important objects in the image data. The second step can include passing region proposals to a neural classification architecture, commonly a region-based convolutional neural network (RCNN) based hierarchical grouping algorithm, or region of interest (ROI) pooling in a fast RCNN. These approaches are provided for the tradeoff of increased accuracy, but decreased speed.

One-step object detection can be utilized for real-time object detection. One-step object detection architectures can process image data faster than two-step object detection architectures. One-step object detection architectures can include you only look once (YOLO), single shot multibox detector (SSD), and RetinaNet. The one-step object detection architectures combine the detection and classification steps by regressing bounding box predictions. Each determined bounding box can be represented with a few coordinates, making it easier to combine the detection and classification steps and speed up processing. The computer vision machine learning model can utilize one-step object detection.

The image element detection module 208A, in conjunction with the processor 204, can train the computer vision machine learning model (e.g., an item tag identification machine learning model). For example, the image element detection module 208A, in conjunction with the processor 204, can obtain a set of image data from the image database 106. The image element detection module 208A, in conjunction with the processor 204, can apply one or more preprocessing methods to each image data including mirroring, rotating, smoothing, contrast reduction, noise reduction, scaling, rectifying, etc. to create a preprocessed set of image data.

After preprocessing each image data in the set of image data, the image element detection module 208A, in conjunction with the processor 204, can create a training set comprising the preprocessed set of image data. The image element detection module 208A, in conjunction with the processor 204, can train the computer vision machine learning model in a training iteration using the training set. The image element detection module 208A, in conjunction with the processor 204, can iteratively train the computer vision machine learning model.

During each training iteration, the image element detection module 208A, in conjunction with the processor 204, can optimize a loss function based on values determined during training. The image element detection module 208A, in conjunction with the processor 204, can optimize the loss function to update weights in the computer vision machine learning model.

After training the computer vision machine learning model, the image element detection module 208A, in conjunction with the processor 204, can utilize the computer vision machine learning model during an inference phase. The image element detection module 208A, in conjunction with the processor 204, can perform an item tag detection process using the image data. The item tag detection process can identify the item tags that are included in the image data. The item tag detection process can include a machine learning model that is trained to identify item tags in image data. During the item tag detection process, the image element detection module 208A, in conjunction with the processor 204, can determine a plurality of item tags that include machine readable codes. The image element detection module 208A, in conjunction with the processor 204, can utilize the machine readable code on each item tag as well as other item information on the item tag (e.g., item name, item price, etc.) to obtain item data for the item tag.

The image element detection module 208A, in conjunction with the processor 204, can identify one or more machine readable codes in an item tag. The item tag can be a portion of an image that includes an item tag. The image element detection module 208A, in conjunction with the processor 204, can train a machine readable code identification machine learning model. For example, the image element detection module 208A, in conjunction with the processor 204, can obtain a set of images of item tags that include machine readable codes. The image element detection module 208A, in conjunction with the processor 204, can apply one or more preprocessing methods to each image. After preprocessing each image of an item tag, the image element detection module 208A, in conjunction with the processor 204, can create an item tag training set comprising the preprocessed set of images of item tags. The image element detection module 208A, in conjunction with the processor 204, can train the machine readable code identification machine learning model in a training iteration using the item tag training set. The image element detection module 208A, in conjunction with the processor 204, can iteratively train the machine readable code identification machine learning model to identify machine readable codes in images of item tags.

After training the machine readable code identification machine learning model, the image element detection module 208A, in conjunction with the processor 204, can utilize the machine readable code identification machine learning model during an inference phase. The image element detection module 208A, in conjunction with the processor 204, can perform a machine readable code detection process using an image of an item tag. The machine readable code detection process can identify a machine readable code that is included in the image of the item tag.

As an illustrative example, the image element detection module 208A, in conjunction with the processor 204, can identify item tags in the image data using a first computer vision machine learning model. After identifying the item tags, the image element detection module 208A, in conjunction with the processor 204, can identify one or more machine readable codes in the item tags in the image data using a second computer vision machine learning model.

The image processing module 208B may comprise code or software, executable by the processor 204, for processing image data. The image processing module 208B, in conjunction with the processor 204, can modify image data. For example, the image processing module 208B, in conjunction with the processor 204, can resize image data, threshold image data pixel values, perform morphological operations on image data, increase the contrast of image data, rectify image data, and perform any other image modification methods.

As an example, the image processing module 208B, in conjunction with the processor 204, can resize image data and/or sections of data from the image data. For example, the image processing module 208B, in conjunction with the processor 204, can resize image data of a shelf unit. The image processing module 208B, in conjunction with the processor 204, can also resize a portion of the image data that includes a machine readable code.

As another example, the image processing module 208B, in conjunction with the processor 204, can perform image rectification. Image rectification can include a transformation process used to project images onto a common image plane. For example, a machine readable code on an image tag may have a normal vector that is not directly pointing at the camera when the image data is captured. The image processing module 208B, in conjunction with the processor 204, can rectify (e.g., skew) an image of a machine readable code, such that the machine readable code appears to be coplanar with the camera.

The planogram creation module 208C may comprise code or software, executable by the processor 204, for creating planograms. The planogram creation module 208C, in conjunction with the processor 204, can identify item tags in a combined image that is stitched together from a plurality of images. The planogram creation module 208C, in conjunction with the processor 204, can identify items that correspond to the item tags.

The planogram creation module 208C, in conjunction with the processor 204, can generate nodes based on the item tags and/or the items. The planogram creation module 208C, in conjunction with the processor 204, can obtain data related to the item tags and/or the items such as name, price, size, color, location in the image, item description, etc. The planogram creation module 208C, in conjunction with the processor 204, can obtain the data related to the item tags and/or the items by extracting the data from the image and/or from an item database using the identified item tag and/or the identified item.

As an illustrative example, the planogram creation module 208C, in conjunction with the processor 204, can identify a book and a corresponding item tag on a shelf unit. The planogram creation module 208C, in conjunction with the processor 204, can determine the name of the book using an OCR process to read the name of the book, using a YOLO machine learning model, or using a machine readable code that is on the item tag. The planogram creation module 208C, in conjunction with the processor 204, can generate an item lookup request message comprising the name of the book. The planogram creation module 208C, in conjunction with the processor 204, can provide the item lookup request message to an item database. The planogram creation module 208C, in conjunction with the processor 204, can receive an item lookup response message from the item database that comprises item data about the book such as an International Standard Book Number (ISBN), an author name, a weight, a short description, and a cover image. The planogram creation module 208C, in conjunction with the processor 204, can generate a node for the planogram that represents the book. The planogram creation module 208C, in conjunction with the processor 204, can generate a node that includes the item data related to the book.

The planogram creation module 208C, in conjunction with the processor 204, can generate edges based on the locations of the item tags. The planogram creation module 208C, in conjunction with the processor 204, can generate an edge between two nodes based on the relative positioning of the two nodes in the originating image(s). The planogram creation module 208C, in conjunction with the processor 204, can generate an edge that includes a directionality that indicates an angle relative to a horizontal horizon unit vector and includes a length that indicates a distance between the two item tags and/or items on the shelf unit. The distance can be in any suitable unit (e.g., centimeters, inches, feet, etc.).

The network interface 206 may include an interface that can allow the image analysis computer 108 to communicate with external computers. The network interface 206 may enable the image analysis computer 108 to communicate data to and from another device (e.g., the image database 106, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

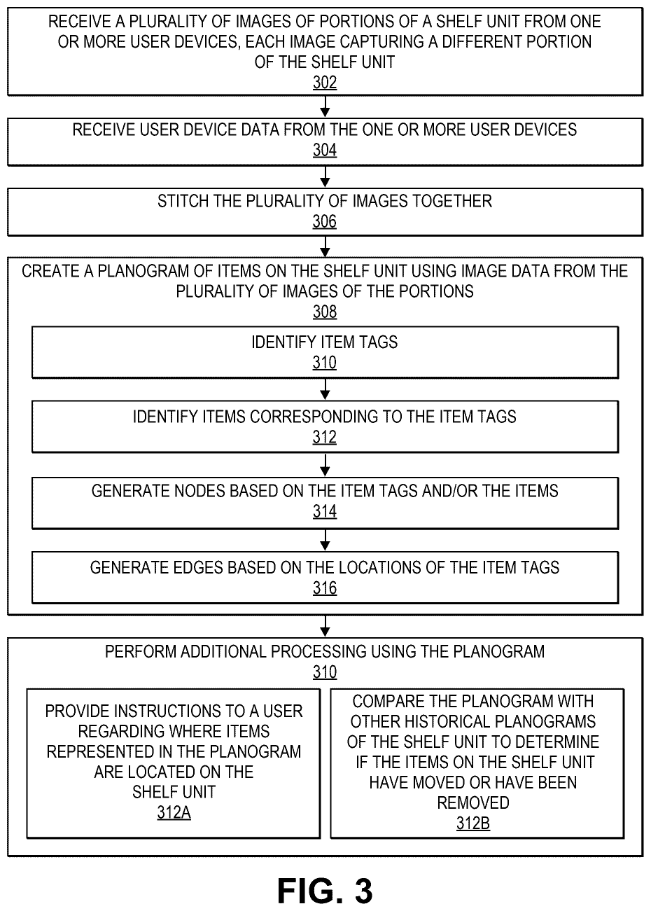

FIG. 3 shows a flowchart illustrating an image processing method according to embodiments. The method illustrated in reference to FIG. 3 will be described in the context of the image analysis computer 108 analyzing images and creating a planogram based on the images.

Prior to step 302, a user, who can be a transporter, can obtain image data at a resource provider location using the user device 102. For example, the user device 102 can include a camera and can capture images using the camera. The user device 102 can capture one or more images of a shelf unit at the resource provider location. Each image can capture a different portion of the shelf unit.

In some embodiments, the plurality of images can be derived from a video. For example, the user device 102 can capture a video. The user device 102 can derive the plurality of images from the video.

In some embodiments, the plurality of images are derived from multiple pictures of the shelf unit taken by one user device operated by a user. In other embodiments, the plurality of images are derived from multiple pictures of the shelf unit taken by a plurality of user devices operated by a plurality of users.

After obtaining image data, the user device 102 can provide the image data to the central server computer 104. Upon receiving the image data, the central server computer 104 can store the image data into the image database 106.

In some embodiments, the user device 102 can obtain device data that is related to the user device 102 at the point in time at which the image is captured. The device data can include positional data (e.g., positional data for the user device 102 relative to the shelf unit), camera data (e.g., shutter speed, ISO, aperture, etc.), device software data (e.g., camera related software settings, fulfillment application data, etc.), etc. The user device 102 can provide the device data to the central server computer 104 along with the image data. Each image of the image data can correspond to device data. The central server computer 104 can store the device data into the image database 106 in association with the corresponding images of the image data.

The device data can be created using any software and/or hardware in the user device 102. For example, the user device 102 can create (e.g., capture) device data that includes positional data that is generated using an accelerometer in the user device 102.

At step 302, the image analysis computer 108 can obtain a plurality of images of portions of a shelf unit from one or more user devices. The image analysis computer 108 can obtain the plurality of images from the image database 106.

For example, the image analysis computer 108 can obtain 10 images from the image database 106. Five of the images can be the images that were captured by the user device 102, while the remaining five images can be images that were captured by a different user device.

In some embodiments, at step 304, after obtaining the plurality of images, the image analysis computer 108 can obtain user device data. The image analysis computer 108 can obtain user device data for each image of the plurality of images. The image analysis computer 108 can obtain the user device data from the image database 106.

At step 306, after obtaining the plurality of images, the image analysis computer 108 can stich the images of the plurality of images together. The image analysis computer 108 can perform an image stitching process using the plurality of images. Image stitching is the process of combining multiple photographic images with overlapping fields of view to produce a segmented panorama or high-resolution image. In order to estimate image alignment, methods can determine the appropriate mathematical model that relates pixel coordinates in one image to pixel coordinates in another image. Methods that combine direct pixel-to-pixel comparisons with gradient descent and/or other optimization techniques can be used to estimate these parameters. Distinctive features can be found in each image and then matched to establish correspondences between pairs of images. The computer can utilize a final compositing surface onto which to warp or projectively transform and place all of the aligned images.

The image stitching process can be described as three core phases: image registration, image calibration, and image blending.

Image registration is the process of transforming different sets of data into one coordinate system. The data can be multiple images. Image registration involves matching features in a set of images or using direct alignment methods to search for image alignments that minimize the sum of absolute differences between overlapping pixels. Image registration methods can be classified into intensity-based methods and feature-based methods. One of the images of the plurality of images is referred to as the target image (e.g., baseline image) and the other images of the plurality of images are referred to as the moving images. Image registration involves spatially transforming the moving images to align with the target image. The reference frame in the target image is stationary, while the other moving images are transformed to match to the target image. Intensity-based methods compare intensity patterns in images via correlation metrics. Feature-based methods find correspondence between image features such as points, lines, and contours. It is further understood that combinations of intensity-based methods and feature-based methods can be utilized. The image analysis computer 108 can perform image registration as known to one of skill in the art.

After performing image registration, the image analysis computer 108 can perform image calibration. Image calibration aims to minimize differences between an ideal lens model and the camera-lens combination that was used, optical defects such as distortions, exposure differences between images, vignetting, camera response, and chromatic aberrations (e.g., as indicated by the device data). In some cases, if feature detection methods were used to register images and absolute positions of the features were recorded and saved, the image analysis computer 108 can use the feature information for geometric optimization of the images in addition to placing the images on a panosphere (e.g., a 360 degree panorama).

During image calibration, the image analysis computer 108 can perform an alignment process to transform a moving image to match the view point of a target image that the moving image with which it is being composited. Alignment can include a change in the coordinates system of a moving image such that the moving image adopts a new coordinate system that matches the required viewpoint of the target image. Example types of transformations an image may go through include pure translation, pure rotation, a similarity transform which includes translation, rotation and scaling of the image which needs to be transformed, and affine or projective transform.

The image analysis computer 108 can modify each image to correct for skew of a moving image compared to the target image. For example, the image analysis computer 108 can perform pitch, yaw, roll, and scale correction as well as edge warping correction or filtering.

After performing image calibration, the image analysis computer 108 can perform image blending. Image blending can involve executing the adjustments identified in the image calibration stage, combined with the remapping of the images to an output projection. Colors can be adjusted between images to compensate for exposure differences. The image analysis computer 108 can blend the images of the plurality of images together and can perform seam line adjustment to minimize the visibility of seams between images.

At step 308, after stitching the plurality of images together to form a combined image, the image analysis computer 108 can create a planogram. The image analysis computer 108 can create a planogram of items on the shelf unit using the combined image that is derived from the image data from the plurality of images of the portions. The image analysis computer 108 can create the planogram that includes nodes and edges. The nodes can correspond to item tags associated with items on the shelf unit. The edges can correspond to vectors between adjacent item tags.

To generate the planogram, the image analysis computer 108 can identify item tags in the combined image and can identify items corresponding to the item tags in the combined image. The image analysis computer 108 can use the identified item tags and the identified items to generate nodes and edges for the planogram. The image analysis computer 108 can label the nodes with names of the identified items.

The image analysis computer 108 can generate the planogram as described in steps 310-316.

At step 310, the image analysis computer 108 can identify item tags in the combined image. The image analysis computer 108 can identify the item tags using a machine learning model, which can be a computer vision machine learning model.

The computer vision machine learning model can include a you only look once (YOLO) machine learning model to identify the item tags. A you only look once model can be a single-shot detector that uses a fully convolutional neural network (CNN) to process image data. Further details regarding you only look once models can be found in “You Only Look Once: Unified, Real-Time Object Detection” by J Redmon et al. 2015 (Arxiv reference arXiv: 1506.02640 [cs.CV]), which is herein incorporated by reference.

In some embodiments, the image analysis computer 108 can identify and then segment the item tags in the image data using the machine learning model. The machine learning model can both identify the item tags and output images that include the item tags. The images that include the item tags can be portions of the image data. As an example, the machine learning model can be a segmentation model can be trained on 1000 tags with a U2 net model for salient object detection.

In some embodiments, the computer vision machine learning model can determine information about the items that are identified in the image data. For example, the computer vision machine learning model can identify that an item on the shelf unit in the image is a bottle of soda of a particular brand. The computer vision machine learning model can determine that the item is a particular category of item (e.g., bottle of soda, bottle of water, snack, box of pasta, etc.) that is provided by a particular brand.

At step 312, after identifying the item tags, the image analysis computer 108 can identify items corresponding to the item tags. The image analysis computer 108 can determine item data about the item. The item data can include a name, a shape, a size, an cost, an item category, and other data related to the item on the shelf unit. The image analysis computer 108 can perform one or more methods of identifying the items.

For example, the image analysis computer 108 can identify items in the combined image using a machine readable code on an item tag corresponding to the item. The image analysis computer 108 can process a machine readable code to obtain information about the item. For example, the machine readable code can be a QR code that links to a webpage with item data. As another example, the machine readable code can be a barcode that embeds an item identifier such as a universal product code (UPC), which is a unique 12-digit number. The image analysis computer 108 can then query a database for item data related to the item using the item identifier.

As another example, the image analysis computer 108 can identify the item using text on the item tag (e.g., a shelf tag) corresponding to the item. The image analysis computer 108 can perform an optical character recognition (OCR) process to determine a name of the item or an item identifier that is printed on the item tag.

As another example, the image analysis computer 108 can identify the item using product text on the item. The image analysis computer 108 can perform an optical character recognition (OCR) process to determine a name of the item or an item identifier that is printed on the item itself.

As another example, the image analysis computer 108 can identify the item using computer vision. The image analysis computer 108 can utilize a you only look once (YOLO) machine learning model to determine the item on the shelf unit. The YOLO machine learning model can process the image of the shelf unit and the item and can output an item identifier or an item name based on a classification of the item in the image.

As another example, the image analysis computer 108 can identify the item using historical data associated with a location of the item on the shelf unit. The image analysis computer 108 can identify a location on the shelf unit of the item in a historical planogram. The image analysis computer 108 can determine a node in the historical planogram that is nearest to the location of the item. The image analysis computer 108 can utilize item data from the nearest node for the current item.

At step 314, after identifying the item tags and the items, the image analysis computer 108 can generate the nodes of the planogram based on the item tags and/or the items. The image analysis computer 108 can generate a node for an item tag that includes item data determined about the item tag and/or the item.

For example, the image analysis computer 108 can generate a node for an item tag that is associated with an item that is a box of cereal on the shelf unit. The image analysis computer 108 can generate a node with a name of “XYZ cereal box,” a size of “18 ounces,” a cost of “$5.99,” and a item category of “groceries.”

At step 316, the image analysis computer 108 can generate edges for the planogram based on the distances of the item tags (e.g., represented by the nodes) in the combined image. An edge can include data that indicates the distance between two nodes that are connected with the edge.

In some embodiments, during or after edge generation, the image analysis computer 108 can filter the edges to clarify the graph using a Delaunay algorithm, spectral filtering, and/or sampling techniques.

As an illustrative example, a node can be a data structure that includes a node identifier, an item identifier and/or a list of potential item identifiers associated with confidence levels, a timestamp, a destination edge map that includes references to the edges associated with the node, and a location of the item and/or the node in reference to the originating image. An edge can be a data structure that includes a source node identifier, a destination node identifier, a vector that includes a magnitude and a direction, a general direction (e.g., an enumeration of up, down, left, or right), and a timestamp.

The planogram creation and update processes can be robust to different image qualities. The image analysis computer 108 can obtain images of different qualities and can extract relevant information based on confidence levels of the item tags. For example, the image analysis computer 108 can determine whether or not missing item tags in an image are due to the items being removed from the shelf unit or due to a low quality image such that the item tags could not be determined. The image analysis computer 108 can make such a decision based on the quality of the image (e.g., resolution, dots per inch (DPI), contrast, biases, etc.) as well as the confidence level of item tags or other elements identified in the image.

At step 310, after generating the planogram, the image analysis computer 108 can perform additional processing using the planogram. Additional processing can include storing the planogram in a database (e.g., the planogram database 110) updating the planogram, providing instructions to users based on the planogram, comparing the planogram with historical planograms, providing the planogram to other devices, visualizing the planogram for a user, etc.

As an illustrative example of additional processing, at step 312A, the image analysis computer 108 can provide instructions to a user regarding where items represented in the planogram are located on the shelf unit. For example, the image analysis computer 108 can receive an item location request message from a user device (which can be routed by an intermediate computer such as a central server computer). The item location request message can include a request for a location for an item, an item identifier, and a resource provider location identifier. The image analysis computer 108 can identify a plurality of planograms that are stored in association with a stored resource provider location identifier that matches the resource provider location identifier. The plurality of planograms can correspond to a particular resource provider location (e.g., store). The image analysis computer 108 can identify a planogram of the plurality of planograms that includes a stored item identifier that matches the item identifier. The image analysis computer 108 can identify the location of the item associated with the item identifier based on the location of the node for the item in the planogram. The image analysis computer 108 can generate an item location response message that includes an indication of the location of the item at the resource provider location. For example, the indication of the location can be an aisle number, a shelf number, and/or a shelf section number. The image analysis computer 108 can provide the item location response message to the user device in response to the item location request message.

As an addition illustrative example of additional processing, at step 312B, the image analysis computer 108 can compare the planogram to one or more historical planograms for the same shelf unit (e.g., as identified by an aisle number) The image analysis computer 108 can evaluate differences between the planogram and the one or more historical planograms. The image analysis computer 108 can determine if there are any differences in the nodes and edges in one planogram compared to another planogram. For example, the image analysis computer 108 can determine that an item corresponding to a node in the planogram has moved relative neighboring nodes compared to the node for the same item in a historical planogram. The image analysis computer 108 can also determine that items have been removed from the shelf unit if the node for the item is no longer in the current planogram.

As another example, the image analysis computer 108 can receive one or more additional images of portions of the shelf unit from the one or more user devices. The one or more additional images can include images of the shelf unit that is represented by the planogram. The image analysis computer 108 can receive additional user device data from the one or more user devices that relate to the one or additional images. The image analysis computer 108 can stitch the additional images together if there are more than one. The image analysis computer 108 can generate an additional planogram using the additional images. The image analysis computer 108 can generate the additional planogram as described herein. The image analysis computer 108 can then compare the additional planogram to the current planogram to determine whether or not anything in the additional planogram differs from the current planogram. The image analysis computer 108 can identify differences in nodes and/or edges. The image analysis computer 108 can store the current planogram as a historical planogram and can update the current planogram with the differences identified in the additional planogram.

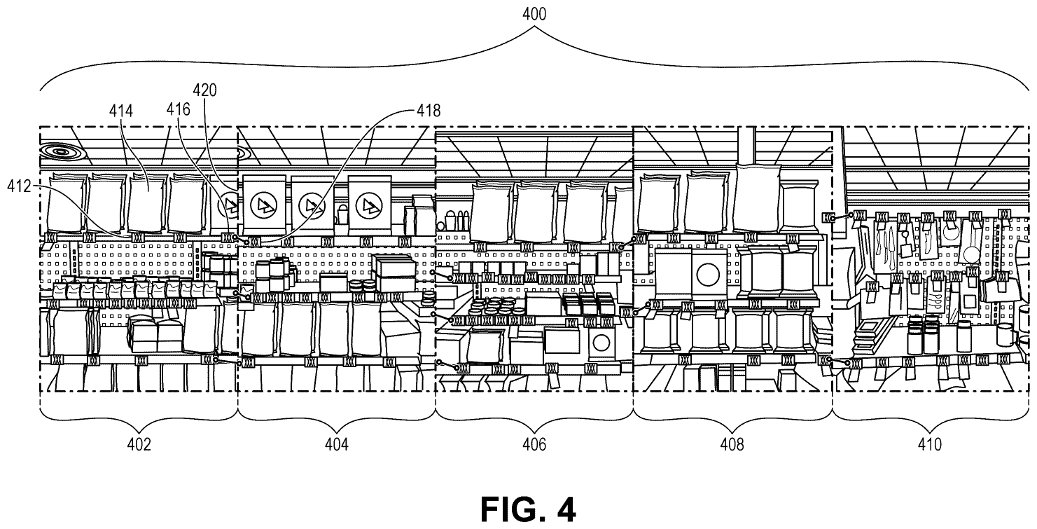

FIG. 4 shows raw images of shelf portions and bounding boxes. FIG. 4 includes a combined image 400 that includes a plurality of images of shelf portions that are stitched together. The combined image 400 illustrates an example point in the stitching process where the images of the plurality of images are arranged in a correct order and features in neighboring image are identified and linked, but the images are not yet composited together to form a seamless combined image.

The plurality of images includes a first image 402, a second image 404, a third image 406, a fourth image 408, and a fifth image 410. The plurality of images can include images that were captured by a user device at a resource provider location.

The image analysis computer 108 can process the plurality of images to identify item tags and items in each image. For example, in the first image 402, the image analysis computer 108 can identify a first item tag 412 and a first item 414 that corresponds to the first item tag 412. The image analysis computer 108 can identify elements in the images using one or more machine learning models, as described in further detail herein.

The combined image 400 can also include a second item tag 416 and a third item tag 418. The second item tag 416 can be identified in the first image 402. The third item tag 418 can be identified in the second image 404. The image analysis computer 108 can compare identified item tags that are proximate (e.g., within a threshold distance) to the edge of each image to identified item tags that are proximate to the edge of other images. The image analysis computer 108 can compare the second item tag 416 to the third item tag 418. For example, the image analysis computer 108 can compare features of each item tag to one another. The image analysis computer 108 can also compare neighboring features that surround the second item tag 416 to the neighboring features that surround the third item tag 418 to further determine whether or not the second item tag 416 is the same item tag on the shelf unit as the third item tag 418.

The image analysis computer 108 can determine that the second item tag 416 matches the third item tag 418 based on the feature of each item tag and/or the neighboring features that surround each item tag. The second item tag 416 can be illustratively linked to the third item tag 418 by an edge 420 to indicate the match. As such, the images can be stitched together using overlapping item tags, items, and/or product images.

After identifying the item tags and stitching the images together to form the combined image 400, the image analysis computer 108 can generate a planogram based on the item tags. The planogram can include a plurality of nodes and a plurality of edges.

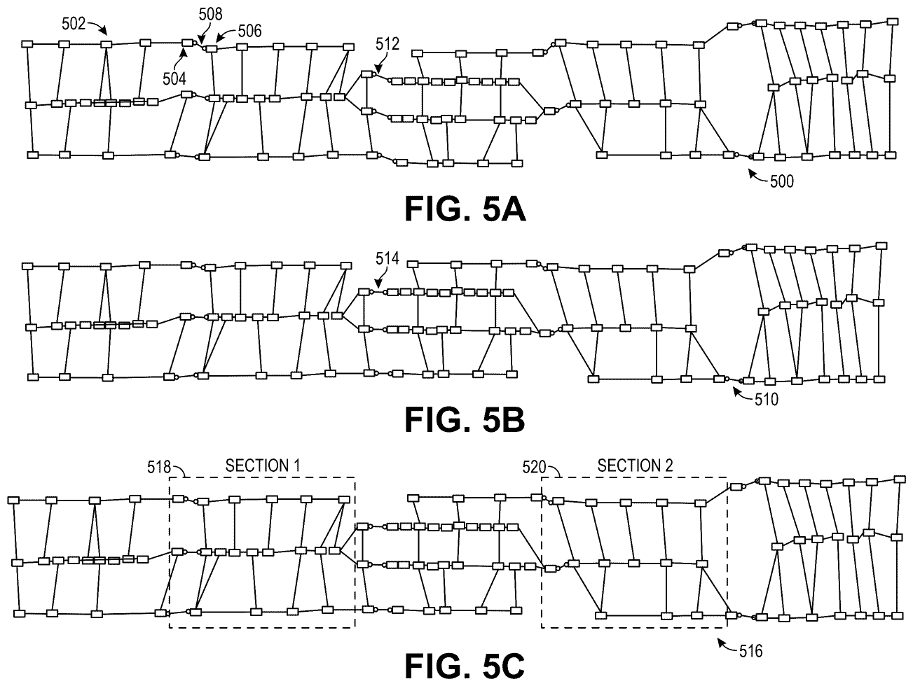

FIG. 5A shows a diagram that illustrates a planogram that shows stitched images according to embodiments. The image analysis computer 108 can generate the planogram 500 illustrated in FIG. 5A. The image analysis computer 108 can generate the nodes of the planogram based on the item tags of the combined image 400. The image analysis computer 108 can generate the edges of the planogram based on the relative positioning of each item tag in the combined image to one or more nearby item tags.

The example combined image 400 of FIG. 4 includes images that are combined next to one another, but are not yet stitched together into a seamless image. In such a case, the image analysis computer 108 can perform a normalization step as indicated in FIG. 5B. However, if the plurality of images are stitched together into a seamless image, then the image analysis computer 108 may not need to perform the normalization process of FIG. 5B.

The planogram 500 includes a first node 502, a second node 504, a third node 506, and an edge 508. The first node 502 can be a node that is generated based on the first item tag 412 of the combined image 400. The second node 504 can be a node that is generated based on the second item tag 416. The third node 506 can be a node that is generated based on the third item tag 418.

The second node 504 and the third node 506 can correspond to the same item tag on the shelf unit that appeared in two different images that were used to create the combined image 400. In some embodiments, if an item tag appears in two different images, then the image analysis computer 108 can generate a two nodes for the planogram 500, one node for each instance of the item tag. The image analysis computer 108 can generate the edge 508 that indicates a match between the two connected nodes. The edge 508 can indicate a boundary between two different images that were utilized to create the combined image 400. The edge 508 that indicates the boundary between the two different images can be of a predetermined and fixed length such that the resulting planogram 500 includes a subgraph for each image that are connected by the fixed length boundary connection edges.

In other embodiments, the image analysis computer 108 can deduplicate the appearance of the item tag in two or more images. For example, the image analysis computer 108 can generate a single node that represents each instance of the item tag across the images.

FIG. 5B shows a normalized planogram 510 showing position normalization according to embodiments. The nodes in the planogram 500 can be readjusted such that the nodes approximately correspond to their actual physical locations on the shelf unit to form a normalized planogram 510. The image analysis computer 108 can perform the position normalization process if the originating combined image was not formed as a seamless image. In a seamless image, the positions of the items that correspond to the nodes are already normalized.

Position normalization can include adjusting the positions of the nodes of the planogram 500. The image analysis computer 108 can adjust the positions of the nodes of the planogram 500 to form the normalized planogram 510. The image analysis computer 108 can adjust the positions of the nodes based on the relative position of each node in each image to the nodes in a neighboring image of the planogram 500.

The image analysis computer 108 can evaluate the positions of the items, corresponding to the nodes, in an image compared to a neighboring image. The image analysis computer 108 can perform the stitching process, as described in detail herein, to perform position normalization of the nodes in the normalized planogram 510.

As an illustrative example, a first edge 512 in the planogram 500 connects nodes across two different images. The image analysis computer 108 can modify the position of the nodes, derived from an image, based on the determined shift and skew of the image relative to a neighboring image. As such, the directionality of the first edge 512 can be modified to be the second edge 514.

FIG. 5C shows a planogram 516 that can be a sectioned planogram according to embodiments. FIG. 5C shows that partial planograms of a the planogram 516 can be loaded, analyzed, and manipulated. The image analysis computer 108 can load nodes and edges in a particular portion of the planogram 516. For example, the image analysis computer 108 can load and modify nodes and edges that are within a first portion 518 and/or a second portion 520.

In some embodiments, the image analysis computer 108 can load a portion of the planogram 516 that corresponds to a particular originating image. The image analysis computer 108 can overlay an original shelf image over the corresponding portion of the planogram 516. The image analysis computer 108 can modify the image (e.g., skew, stretch, etc.) to align with the nodes of the portion.

In other embodiments, the image analysis computer 108 can utilize data from each edge to display the planogram 516 in a particular manner to a user. For example, the image analysis computer 108 can highlight nodes in the planogram 516. The image analysis computer 108 can identify nodes that correspond to item tags that are of a particular type of item. The image analysis computer 108 can adjust the color, shape, shading, etc. of a node. For example, the image analysis computer 108 can adjust the color of nodes corresponding to cooking utensils to be orange and can adjust the color of nodes corresponding to cat food to be red. The image analysis computer 108 can also, for example, modify the shape of nodes that are recently scanned (e.g., within the last hour, day, week, etc.) to circles.

In some embodiments, the planogram 516 can represent an aisle at a resource provider location (e.g., a physical location such as a store). The image analysis computer 108 can create and maintain a different planogram for different aisles at the resource provider location. Each planogram can be identified using a resource provider identifier, a resource provider location identifier, and an aisle identifier.

As new images are obtained, the image analysis computer 108 can determine new nodes and edges for the image and can compare the new nodes and edges to nodes and edges of the planogram 516. The image analysis computer 108 can identify nodes and edges in the planogram 516 that match the new nodes and edges. The image analysis computer 108 can update the nodes and edge of the planogram 516 based on the new nodes and edges.

For example, an item on a shelf unit may be replaced with a different item. The image analysis computer 108 can identify that all new nodes and edges from the new image match the nodes and edges of the planogram 516 except that one node of the new nodes corresponds to a different item tag than previously used to create a node at the same planogram location. The image analysis computer 108 can update the node of the planogram 516 with the new node for the replaced item.

In some cases the image data of the shelf units can be overlapping. Two images can include the same portion of the shelf unit. The overlapping portions of the image data can be combined together to form a larger planogram than a planogram for a single image. The image analysis computer 108 can extract adjacency information between items from one or more images that can overlap with one another. The image analysis computer 108 can create a planogram of items that extends across a plurality of images. A planogram generated from a plurality of images of shelf units can be referred to as a virtual aisle. The virtual aisle can have a topological structure that mirrors that of the real shelf unit.

By checking overlaps between images in both newly scanned images and historical images, the image analysis computer 108 can find common items and groupings of items between images. The image analysis computer 108 can also check if there's significant overlap between current virtual aisles and historical virtual aisles.

A planogram can be stored in any suitable format that can be utilized to store a graph comprising nodes and edges. For example, the planogram can be formatted as a JSON file. Table 1, below, illustrates an example planogram that includes a node as formatted using JSON. The data structure illustrated in Table 1 can include data such as a resource provider location identifier (e.g., a store identifier), an aisle identifier, image data, and node data.

TABLE 1
Example node data in a planogram

```
{
  “store_id”: “9114”,
  “aisle_id”: “aisle-1”,
  “last_update_time”: “2024-05-29T00:00:00Z”,
  “width”: 1600.0,
  “height”: 400.0,
  “item_list”: [
    {
      “node_id”: “1”,
      “bounding_box”: {“center_x”: 300.0, “center_y”: 150.0,
      “width”:
      50.0,“height”: 40.0},
      “resolved_item_id”: “1234”,
      “confidence”: 0.8,
      “is_oos”: false,
      “signals”: [
        {
          “source_image_url”: “xyzabc.com/image.jpg”,
          “source_image_bounding_box”: {“center_x”: 300.0,
          “center_y”: 150.0, “width”: 50.0, “height”: 40.0},
          “event_time”: “2024-05-29T00:00:00Z”,
          “ocr_data”: {“ocr_result”: [“XYZ_Drink”, “$4.99”]}
        },
        {
          “source”: “barcode”,
          “sub_source”: “reconstruction”,
          “source_image_url”: “xyzabc.com/image.jpg”,
          “source_image_bounding_box”: {“center_x”: 300.0,
          “center_y”: 150.0, “width”: 50.0, “height”: 40.0},
          “event_time”: “2024-05-28T00:00:00Z”,
          “confidence”: 0.9,
          “item_id”: “1234”,
          “barcode_data”: {“barcode”: “1234”, “barcode_type”:
          “VNBarcodeSymbologyI2of5”},
          “ocr_data”: {
          “ocr_result”: [“XYZ_Drink”, “$4.99”],
          “ocr_candidates”: [{“source”: “inventory”,
          “item_id”: “1234”, “item_name”: “XYZ_Drink”,
          “price”: 4.99}]
        }
      },
      {
          “source”: “ocr”,
          “sub_source”: “historical-ocr”,
          “source_image_url”: “xyzabc.com/image.jpg”,
          “source_image_bounding_box”: {“center_x”: 300.0,
          “center_y”: 150.0, “width”: 50.0, “height”: 40.0},
          “event_time”: “2024-05-28T00:00:00Z”,
          “confidence”: 0.7,
          “item_id”: “1234”,
          “ocr_data”: {
            “ocr_result”: [“XYZ_Drink”, “$4.99”],
            “ocr_candidates”: [{“source”: “historical”,
            “item_id”: “1234”, “item_name”: “XYZ_Drink”,
            “price”: 4.99, “historical_raw_text”:
            [“XYZ_Drink”, “$4.99”]}]
          }
        }
      ]
    }
  ]
}
```

The example data structure illustrated in Table 1 shows that the node associated with the node identifier of 1 includes data determined from multiple sources. The node includes an array of signals that indicate data obtained from different sources. The node include data from a first signal of a source image as indicated by a source image URL, a second signal of a reconstructed barcode on the item tag associated with the item, and a third signal obtained from an optical character recognition (OCR) process.

Each source can include data about the item that was able to be determined using the source method. For example, the OCR process can obtain an item name and item price by analyzing characters on the item tag and/or on the item itself. Each source can also correspond to a confidence level based the accuracy of the determination of the data from the source.

The example data structure can also include information related to the originating image of the shelf unit and bounding boxes corresponding to sub images for the item and/or the item tag on the shelf unit. In some embodiments, an item tag bounding box can be represented with respect to the planogram width and height while the source image bounding box can be represented with respect to the source image width and height.

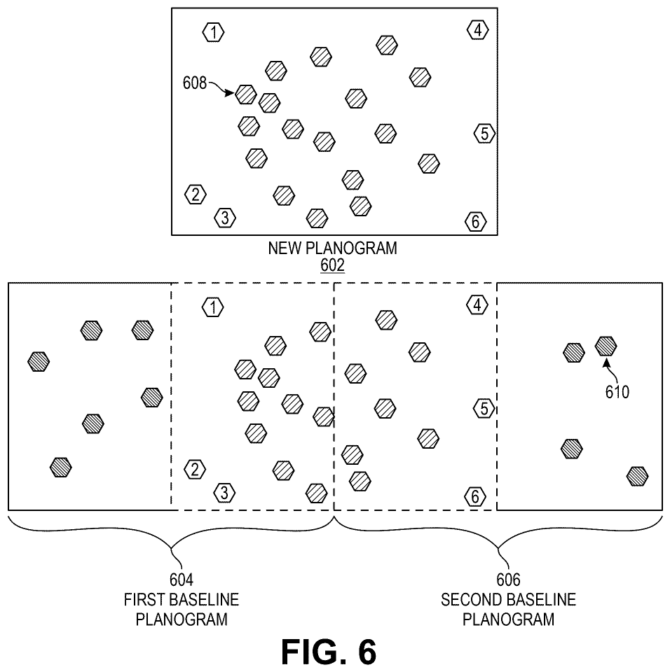

FIG. 6 shows a diagram illustrating a bounded search according to embodiments. Each image can provide spatial information of items. The image analysis computer 108 can compare new images and planograms created therefrom to baseline images and planograms created therefrom. For example, FIG. 6 includes a new planogram 602 and two baseline planograms including a first baseline planogram 604 and a second baseline planogram 606.

The new planogram 602 can be a newly obtained planogram of a shelf unit. The image analysis computer 108 can compare the new planogram 602 to a plurality of historical planograms. The image analysis computer 108 can determine that the new planogram 602 matches portions of the first baseline planogram 604 and the second baseline planogram 606. The new planogram 602 can include a plurality of nodes, such as the example node 608. The first baseline planogram 604 and the second baseline planogram 606 can include a plurality of nodes, such as the example node 610.

The image analysis computer 108 can determine that a first portion of the new planogram 602 matches a portion of the first baseline planogram 604 and that a second portion of the new planogram 602 matches a portion of the second baseline planogram 606. For example, the first baseline planogram 604 can match with a left portion of the new planogram 602, while the second baseline planogram 606 can match with a right portion of the new planogram 602.

The image analysis computer 108 can determine the matching portions by comparing the nodes and edges of the new planogram 602 to the historical planograms. For example, a layout of nodes may be similar between two different planograms and can indicate that the two planograms overlap with one another. In some embodiments, the image analysis computer 108 can use nodes on the perimeter of the new planogram 602 to search for matches in other historical planograms. In some embodiments, the perimeter can include all four edges of the image, or can include the left edge and the right edge of the image.

For example, the image analysis computer 108 can identify the nodes around the perimeter of the new planogram 602. The image analysis computer 108 can determine the nodes 1, 2, 3, 4, 5, and 6 in the new planogram 602. The image analysis computer 108 can identify that the nodes 1, 2, and 3 match in both item identifiers and relative layout in the new planogram 602 and the first baseline planogram 604. The image analysis computer 108 can identify that the nodes 4, 5, and 6 match in both item identifiers and relative layout in the new planogram 602 and the second baseline planogram 606.

The image analysis computer 108 can determine how the new planogram 602 overlaps with the first baseline planogram 604 and the second baseline planogram 606 based on the identified matching perimeter nodes.

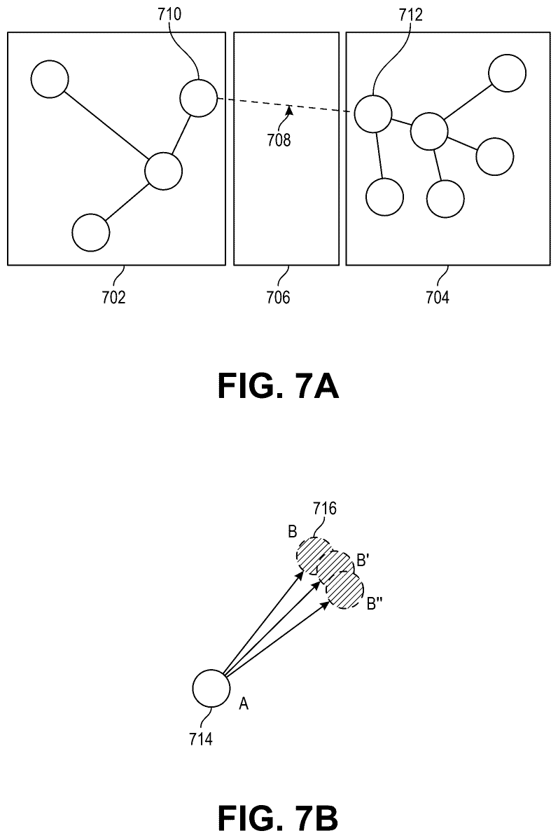

FIG. 7A shows a diagram illustrating disjoint subgraphs in an aisle planogram according to embodiments. Disjoint subgraphs can exist within an aisle (e.g., due to images not being contiguous or other errors). Two graphs can be disjoint if they have no common vertices. If two graphs have no common edges then the graphs are referred to as edge-disjoint. The planogram can be disjoint or edge-disjoint.

FIG. 7A includes a first portion 702 of a shelf unit, a second portion 704 of the shelf unit, and a third portion 706 of the shelf unit. A planogram may be disjoint if two images are captured that are not overlapping. For example, a first image may capture the first portion 702. A second image may capture the second portion 704. However, the third portion 706 of the shelf unit may be present between the first portion 702 and the second portion 704.

As such, the planogram may be split into two different graphs. The image analysis computer 108 can determine that the graph corresponding to the first portion 702 is disjoin from the graph corresponding to the second portion 704.

The image analysis computer 108 can generate an edge 708 to connect the two disjoint graphs. For example, the image analysis computer 108 can identify a node in the first image that is nearest towards the second image. The image analysis computer 108 can determine that a first node 710 in the first image is closest to the second image. The image analysis computer 108 can identify a node in the second image that is nearest towards the first image. The image analysis computer 108 can determine that a second node 712 in the second image is closest to the first image. The image analysis computer 108 can generate the edge 708 to connect the first node 710 to the second node 712.

For example, the image analysis computer 108 can create a plurality of planogram portions from the plurality of images. Each planogram portion may not be connected via edges if the originating images are not contiguous. The image analysis computer 108 can stitch together the planogram portions to form the planogram. In some embodiments, the image analysis computer 108 can also adjust positions of the nodes and the edges in one or more disjoint subgraphs in the stitched planogram portions such that they more accurately align with other disjoint subgraphs in the stitched planogram.

FIG. 7B shows a diagram showing a plurality of edges between two nodes according to embodiments. Each item tag location in an image can map to a node in the planogram. Each node can have one or more edges to adjacent nodes. Since each image can provide a version of the connection between a first item 714 (item A) and a second item 716 (item B), multiple connections can be stored together between the two nodes. FIG. 7B illustrates the first item 714 (item A) and the second item 716 (item B). The second item 716 is indicated as being at three different locations (e.g., item B, item B′, and item B″).

The presence of a plurality of edges can be due to different images being captured at different angles to one another thus making the images appear to have slightly different relative distances between nodes, calculation errors, or other reasons. The image analysis computer 108 can generate a plurality of edges for each pair of nodes. In some embodiments, the image analysis computer 108 can utilize the plurality of edges to determine a final edge vector.

When comparing the planogram to a new planogram or image, the image analysis computer 108 can evaluate all adjacent edges of a node. The image analysis computer 108 can determine whether or not the item tag corresponding to the node has been moved on the shelf unit based on the deviation of the new edge to the plurality of previous edges. Further, by having a plurality of previous edges, the image analysis computer 108 can perform statistical analysis to determine whether or not the difference of the new edge is statistically significant from the plurality of previous edges to indicate a change in position of the node.

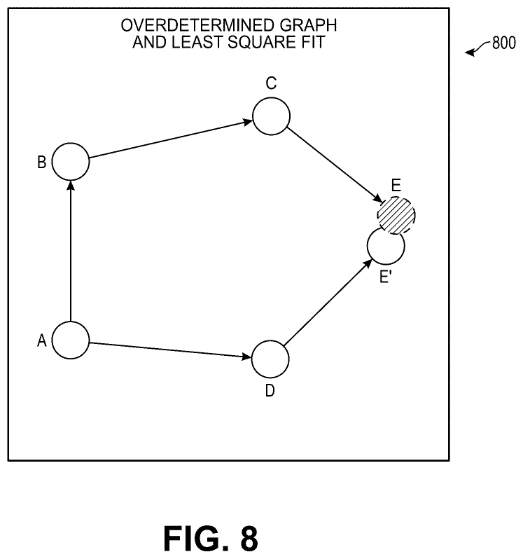

FIG. 8 shows a diagram illustrating an overdetermined graph and a least square fit according to embodiments. FIG. 8 illustrates a graph 800 that is an overdetermined graph that indicates an issue that may arise due to multiple pathways of edges to reach the same node. The image analysis computer 108 can perform a best fit analysis to calculate final positions of nodes relative to one another.

The image analysis computer 108 can utilize a least squares analysis (e.g., method of least squares) to optimize the final positions of the nodes relative to one another. The method of least squares is a mathematical optimization technique that aims to determine the best fit function by minimizing the sum of the squares of the differences between the observed values and the predicted values of the model.

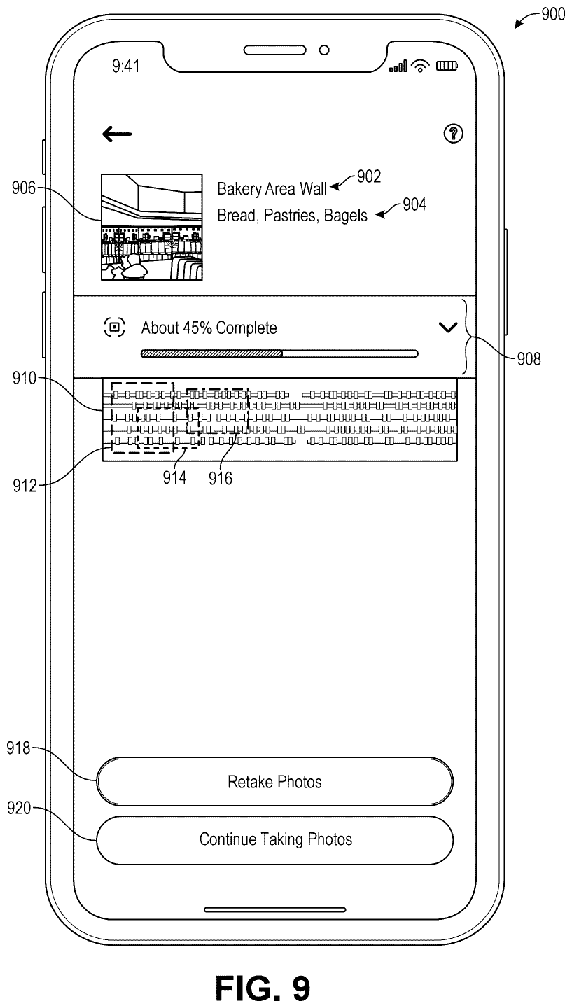

FIG. 9 shows a diagram showing a user interface 900 that illustrates progress of a user capturing images of a shelf unit according to embodiments. The user interface 900 can be displayed to a user on a user device. The user interface 900 can be displayed by a fulfilment application installed on the user device. The fulfilment application can aid in the fulfilment of deliveries of items from resource provider locations to end user locations. The fulfilment application can request users (e.g., transporters, end users, resource providers, etc.) to capture images of shelf units at a resource provider location. The users can be presented with the user interface 900 to aid in capturing the images.

The user interface 900 illustrated in FIG. 9 can indicate a shelf unit that corresponds to an existing planogram. The user interface 900 can request the user to capture additional images of the shelf unit to update the planogram.

The user interface 900 includes a shelf unit identifier 902, a list of example items 904, a preview image 906, a total progress indicator 908, and a visual progress indicator 910. The user interface 900 also includes a retake photo button 918 and a continue button 920.

The shelf unit identifier 902 can be a name or a number that identifies a particular shelf unit at a resource provider location. The shelf unit identifier 902 can uniquely identify a shelf unit.

The list of example items 904 can indicate types of items and/or categories of items that are representative of items that are found on the shelf unit indicated by the shelf unit identifier 902. The user can utilize the list of example items 904 to identify the shelf unit.

The preview image 906 can be an image that shows the shelf unit and/or an area at the resource provider location at which the user can capture images.

The total progress indicator 908 can display a value and/or a progress bar that indicates a ratio of a number of items on the shelf unit captured in new images compared to the number of items represented as nodes in the planogram. For example, the total progress indicator 908 can display an value of 45% complete, which can indicate that the user has obtained photos of 45 of 100 known items on the shelf unit.

The visual progress indicator 910 can display a visual representation of the planogram and/or the combined image (e.g., panorama) that was used to form the planogram. The visual progress indicator 910 can be overlayed with captured image area bounding boxes including a first bounding box 912, a second bounding box 914, and a third bounding box 916. The bounding boxes can indicate areas on the shelf unit that the user has captured in the additional images. The visual progress indicator 910 can be an image of the shelf unit with overlays showing the portions of the shelf unit and other portions of the shelf unit that have not yet been captured in an image by the camera.

The planogram can be used to visualize and provide guardrails during the scanning session. The user can visualize what they have scanned and what they have missed as using the visual progress indicator 910.

The visual progress indicator 910 can also display the nodes and edges of the planogram to allow the user to identify where items were historically in the planogram if there are any large changes on the shelf unit. The visual progress indicator 910 can aid the user in capturing images of the entire shelf unit.

The retake photo button 918 can allow the user to retake a previously captured image. For example, the user can press the retake photo button 918 to retake an image that corresponds to the third bounding box 916. The continue button 920 can allow the user to capture a next image to obtain more image coverage of the shelf unit.

FIG. 10 shows a system 1000 according to embodiments of the disclosure. The system in FIG. 10 can be used to coordinate and facilitate the delivery of items from a service providers (e.g., restaurants, grocery stores, etc.) to end users. When items are delivered to end users, transporters can take pictures of shelves stocked with items as described above. Since transporters frequently visit service providers with such stocked items, they can regularly take images of the shelves (e.g., many times per day). As a result, up to date planograms and the availability of items can be updated on a frequent basis (e.g., once per hour or once per day). This was not possible in prior systems of inventory management.

The system of FIG. 10 includes a central server computer 1002, a logistics platform 1004, an end user device 1006, an end user 1008, a pickup location 1010, a drop-off location 1012, a transporter user device 1014, a transporter 1016, a navigation network 1020, a service provider computer 1022, the image database 106, the image analysis computer 108. In some embodiments, the system 1000 can include an item information database (not shown).

The central server computer 1002 can be in operative communication with the logistics platform 1004, the end user device 1006, the transporter user device 1014, the navigation network 1020, the service provider computer 1022, and the image database 106. The transporter user device 1014 can be in operative communication with the navigation network 1020. The image database 106 can be in operative communication with the image analysis computer 108.

For simplicity of illustration, a certain number of components are shown in FIG. 10. It is understood, however, that embodiments of the invention may include more than one of each component. In addition, some embodiments of the invention may include fewer than or greater than all of the components shown in FIG. 10. For example, although FIG. 10 shows one transporter 1016, there can be two, three, or more transporters, transporter user devices, etc.

Messages between the devices and the computers in the system 1000 in FIG. 10 can be transmitted using a secure communications protocols as described herein.

The central server computer 1002 can be the central server computer 104. The central server computer 1002 can include a computer that can facilitate in the fulfillment of fulfillment requests received from the end user device 1006. For example, the central server computer 1002 can identify the transporter 1016 (from among many candidate transporters) operating the transporter user device 1014 as being suitable for satisfying the fulfillment request. The central server computer 1002 can identify the transporter user device 1014 that can satisfy the fulfillment request based on any suitable criteria (e.g., transporter location, service provider location, end user destination, end user location, transporter mode of transportation, etc.).

The central server computer 1002 can receive data relating to a delivery order of items from the service provider computer 1022 to the end user 1008 at the drop-off location 1012. The central server computer 1002 can determine a route for delivery of the delivery order. The central server computer 1002 can present the routes to a plurality of transporter user devices and/or transporters. The central server computer 1002 can receive acceptances from the transporter 1016 that will deliver the items from the pickup location 1010 to the drop-off location 1012.

The central server computer 1002 can receive image data from user devices. For example, the central server computer 1002 can receive image data from the transporter user device 1014. The central server computer 1002 can also receive image data from the end user device 1006. The central server computer 1002 can store the image data into the database 124.

The central server computer 1002 can maintain and update item listings that can be accessible in a delivery application managed by the central server computer 1002. The delivery application can be installed on end user devices and can allow end users to select items from the item listings to have delivered to the end user from a service provider location by a transporter. In some embodiments, the central server computer 1002 can update item listings based on item information data entries in an item information database.

In some embodiments, the central server computer 1002 can maintain and update item listings on the delivery application using modified machine readable codes from the item information database as well as inventory information provided from the service provider computer 1022. For example, the item information database can indicate that a particular item has been identified using a modified machine readable code from an image captured at the service provider location. In some embodiments, the central server computer 1002 can update an item listing for the particular item based on the information from the item information database.

The logistics platform 1004 can include a location determination system, which can determine the locations of various user devices such as transporter user devices (e.g., the transporter user device 1014) and end user devices (e.g., the end user device 1006). The logistics platform 1004 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 1004 can be part of the central server computer 1002 or can be a system that is separate from the central server computer 1002.

The end user device 1006 can include a device operated by the end user 1008. The end user devices 1006 can generate and provide fulfillment request messages to the central server computer 1002. The fulfillment request message can indicate that the request (e.g., a request for a service) can be fulfilled by the service provider computer 1022. For example, the fulfillment request message can be generated based on a cart selected at checkout during a transaction using a central server computer application installed on the end user device 1006. The fulfillment request message can include one or more items from the selected cart.

The end user device 1006 can provide a fulfillment request message to the central server computer 1002 that indicates that the end user device 1006 is requesting that the transporter 1016 pickup an item from the pickup location 1010 (e.g., end user's 1008 location) and deliver the item to the drop-off location 1012 (e.g., the service provider computer's 1022 location).

The pickup location 1010 can be a location in which items are stored. In the context of an outbound delivery from an end user at an end user location, examples of the pickup location 1010 may be a house or an apartment, a mailbox, a service provider location (e.g., a retail store, a grocery store, a dry cleaning store), a pickup hub, etc. Items can first be obtained from a pickup location 1010 and then be transported to the drop-off location 1012. Examples of the drop-off location 1012 can be similar to the pickup location 1010, such as a house or apartment, a mailbox, a retail store, a grocery store, a dry cleaning store, a pickup hub, etc. In one example, the pickup location 1010 can be a pizza parlor from which the end user 1008 orders a pizza. The drop-off location 1012 can be an apartment in which the end user 1008 resides.

The transporter user device 1014 can include a device operated by the transporter 1016. The transporter user device 1014 can include a smartphone, a wearable device, a personal assistant device, etc. The transporter 1016 can accept an end user's fulfillment request via an acceptance message. For example, the transporter user device 1014 can generate and transmit a request to fulfill a particular end user's fulfillment request to the central server computer 1002. The central server computer 1002 can notify the transporter user device 1014 of the fulfillment request. The transporter user device 1014 can respond to the central server computer 1002 with a request to perform the delivery to the end user as indicated by the fulfillment request.

In some embodiments, the transporter 1016 can be an operator of a vehicle. In other embodiments, the transporter 1016 can be a vehicle that can be operated by an operator or can be autonomous. The vehicle can include a car, a truck, a van, a motorcycle, a bicycle, a drone, or other vehicle.

The navigation network 1020 can provide navigational directions to the transporter user device 1014. For example, the transporter user device 1014 can obtain a location from the central server computer 1002. The location can be a service provider parking location, a service provider location, an end user parking location, an end user location, etc. The navigation network 1020 can provide navigational data to the location. For example, the navigation network 1020 can be a global positioning system that provides location data to the transporter user device 1014.

The service provider computer 1022 include computers operated by a service provider. For example, the service provider computer 1022 can be a food provider computer that is operated by a food provider. The service provider computer 1022 can offer to provide services to the end user 1008 of the end user device 1006. In embodiments of the invention, the service provider computer 1022 can receive requests to prepare one or more items for delivery from the central server computer 1002. The service provider computer 1022 can initiate the preparation of the one or more items that are to be delivered to the end user 1008 of the end user device 1006 by the transporter 1016 of the transporter user device 1014.

Embodiments of the invention provide a number of advantages. For example, embodiments provide for technical advantages of being able to extract highly accurate item details (e.g., machine readable code data, names, prices, etc.) using an image of a shelf unit. The systems and methods herein do not rely on specific hardware that is required to capture the images, such as was done in previous methods (e.g., using a handheld barcode scanner).

Embodiments also provide for the advantage of reducing the time and resources taken to create static planogram images that represent items on the shelf unit each time and item on the shelf unit changes. Previously, a resource provider would need to create a static planogram image for a shelf unit that includes shapes of various items on a shelf. The resource provider could use the planogram to plan out where to place the items on the shelf. However, at a point later in time, when an item on the shelf is changed or moved, then the resource provider would need to recreate the planogram by hand. Embodiments provide for the advantage of dynamically updating a graph representation of a planogram (e.g., comprising nodes and edges) using images, thus saving time and resources both in creating the planogram and in updating the planogram.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, a plurality of images of portions of a shelf unit from one or more user devices, each image capturing a different portion of the shelf unit;
creating, by the computer, a planogram of items on the shelf unit using image data from the plurality of images of the portions; and
performing additional processing using the planogram.

2. The method of claim 1, further comprising:
stitching, by the computer, the plurality of images together.

3. The method of claim 1, wherein the items are products in a grocery store.

4. The method of claim 1, wherein the plurality of images are derived from a video.

5. The method of claim 1, wherein the plurality of images are derived from multiple pictures of the shelf unit taken by one user device operated by a user.

6. The method of claim 1, wherein the additional processing comprises providing instructions to a user regarding where items represented in the planogram are located on the shelf unit.

7. The method of claim 1, wherein the planogram comprises nodes and edges, the nodes corresponding to item tags associated with items on the shelf unit and the edges correspond to vectors between adjacent item tags.

8. The method of claim 7, wherein creating the planogram comprises identifying items corresponding to the item tags and labeling the nodes with names of the identified items.

9. The method of claim 8, wherein the one or more user devices comprises a mobile phone.

10. The method of claim 1, wherein the plurality of images of portions of the shelf unit are from one user device, and wherein the one user device uses a camera to obtain the plurality of images, and presenting to a user via the one user device, an image of the shelf unit with overlays showing the portions of the shelf unit and other portions of the shelf unit that have not yet been captured in an image by the camera.

11. The method of claim 1, wherein the additional processing comprises:
comparing the planogram with other historical planograms of the shelf unit to determine if the items on the shelf unit have moved or have been removed.

12. The method of claim 1, further comprising:
receiving, by the computer, device data from the one or more user devices, the device data comprising positional data for the one or more user devices relative to the shelf unit.

13. The method of claim 12, wherein the positional data are generated using an accelerometer in the user device.

14. A computer comprising:
a processor; and
a non-transitory computer readable medium comprising code, executable by the processor for performing operations comprising:
receiving a plurality of images of portions of a shelf unit from one or more user devices, each image capturing a different portion of the shelf unit;
creating a planogram of items on the shelf unit using image data from the plurality of images of the portions; and
performing additional processing using the planogram.

15. The computer of claim 14, wherein the operations further comprise:
stitching, by the computer, the plurality of images together.

16. The computer of claim 14, wherein the planogram comprises nodes and edges, the nodes corresponding to item tags associated with items on the shelf unit and the edges correspond to vectors between adjacent item tags.

17. The computer of claim 14, wherein the operations further comprise:
creating a plurality of planogram portions from the plurality of images.

18. The computer of claim 17, further comprising:
stitching together the planogram portions to form the planogram.

19. The computer of claim 18, further comprising:
adjusting positions of nodes and edges in the stitched planogram portions.

20. A system comprising:
one or more user devices; and
a computer comprising:
a processor; and
a non-transitory computer readable medium comprising code, executable by the processor for performing operations comprising:
receiving a plurality of images of portions of a shelf unit from the one or more user devices, each image capturing a different portion of the shelf unit;
creating a planogram of items on the shelf unit using image data from the plurality of images of the portions; and
performing additional processing using the planogram.
